(19) United States
(12) Patent Application Publication
(10) Pub. No.: US 2024/0251754 A1
(43) Pub. Date: Aug. 1, 2024

(54) BIOMETRIC ANIMAL IDENTIFICATION SYSTEM

(71) Applicant: RapID Lab, Inc., San Francisco, CA (US)

(72) Inventors: Bretton Mark Swope, San Francisco, CA (US); Jeremy R. Hyde, New York, NY (US)

(21) Appl. No.: 18/430,556

(22) Filed: Feb. 1, 2024

Related U.S. Application Data
(60) Provisional application No. 63/442,736, filed on Feb. 1, 2023.

(51) Int. Cl. A01K 11/00; G06V 40/145; G06V 40/50; G06V 40/70

(52) U.S. Cl. CPC A01K 11/006; G06V 40/145; G06V 40/50; G06V 40/70

(57) ABSTRACT

A biometric animal identification system includes a set of jaws including: a first jaw; and a second jaw cooperating with the first jaw to close over and to flatten a portion of an ear of an animal. The system also includes: an optical emitter arranged on the first jaw and configured to emit light toward the second jaw to illuminate the portion of the ear inserted between the first jaw and the second jaw; a camera coupled to the second jaw and defining a field of view intersecting the optical emitter; and a sensor coupled to the set of jaws and configured to output a signal representing closure of the set of jaws over the portion of the ear. The system also includes a controller configured to trigger the camera to capture an image of the portion of the ear, illuminated by the optical emitter, based on the signal.

### CROSS-REFERENCE TO RELATED APPLICATIONS

This Application claims the benefit of U.S. Provisional Application No. 63/442,736, filed on 1 Feb. 2023, which is incorporated in its entirety by this reference.

### TECHNICAL FIELD

This invention relates generally to the field of animal identification and, more specifically, to a new and useful animal identification system in the field of animal identification.

### BRIEF DESCRIPTION OF THE FIGURES

FIG. 1 is a schematic representation of a method for animal identification;

FIG. 2 is a flow diagram of one variation of the method for animal identification;

FIG. 3 is a schematic representation of an animal identification system;

FIG. 4 is a schematic representation of one variation of the animal identification system;

FIG. 5 is a schematic representation of one variation of the animal identification system;

FIG. 6 is a schematic representation of one variation of the animal identification system;

FIG. 7 is a schematic representation of another variation of a portion the animal identification system; and

FIG. 8 is a schematic representation of another variation of the animal identification system.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. System

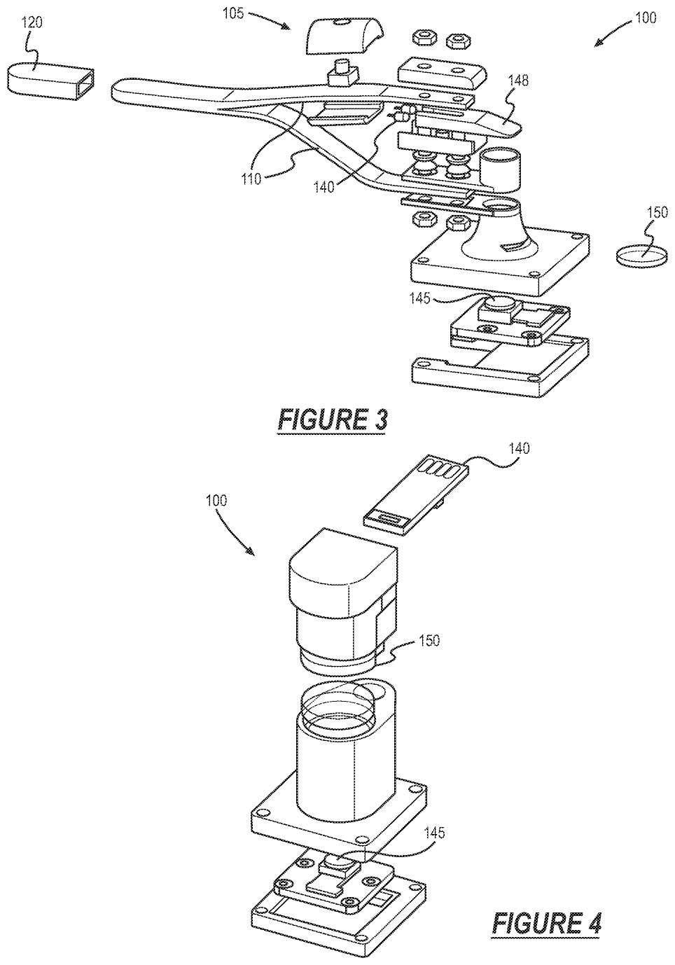

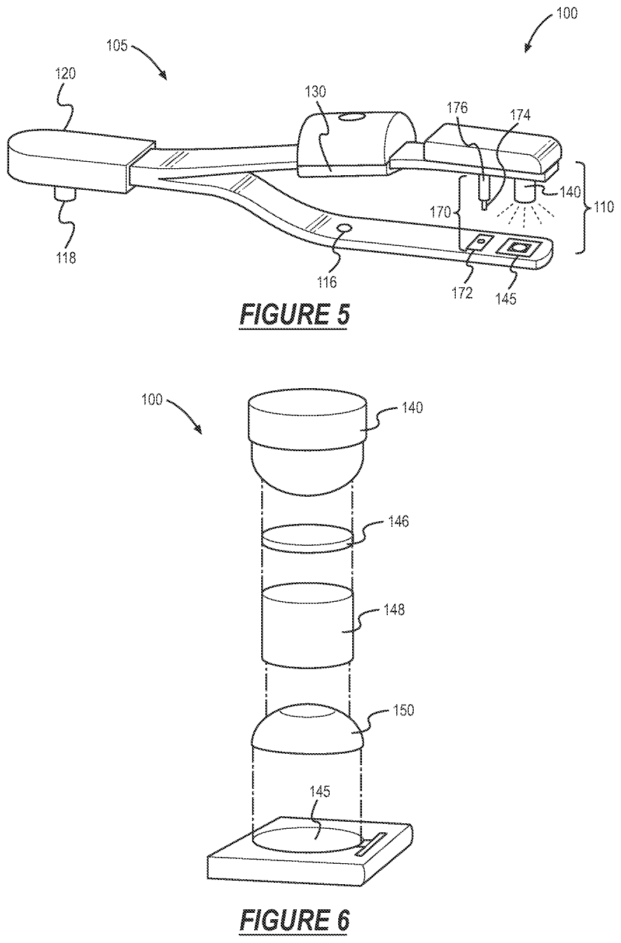

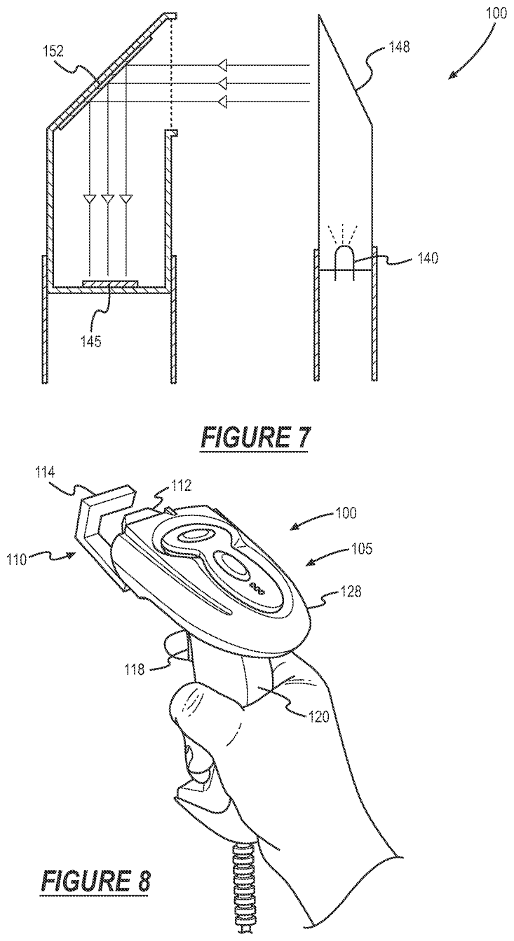

As shown in FIGS. 3-6, an animal identification system 100 includes an applicator 105 including: set of jaws 110 including a first jaw 112 and a second jaw 114 opposing the first jaw 112 and cooperating with the first jaw 112 to cooperatively close over a portion of an ear of an animal; a handle 120 configured to close the set of jaws 110 along a jaw articulation path; a stop 130 configured to prevent the set of jaws 110 from coming into contact with (e.g., pinching) the ear of the animal; an optical emitter 140 configured to emit light along a detection axis toward the set of jaws 110 to illuminate the ear of the animal inserted between the first jaw 112 and the second jaw 114; a lens 150 arranged on the second jaw 114, configured to flatten the ear of the animal inserted between the first jaw 112 and the second jaw 114, and configured to focus and/or diffuse light emitted by the optical emitter 140 across the ear of the animal; and an optical detector 145 arranged along the detection axis and configured to capture an image of the ear of the animal.

The animal identification system 100 also includes a controller 160 configured to: access the image of the ear; detect a set of optical ear features in the image; derive an earprint of the animal from the set of optical ear features; populate an electronic profile of the animal with the earprint, the earprint uniquely identifying the animal; and match the earprint to a stored earprint in an electronic profile to re-identify the animal.

In one variation, the animal identification system 100 further includes a tissue sample collection system 170 including: a die 172 arranged on the first jaw 112 and adjacent the detection axis; and a punch 174 arranged on the second jaw 114 facing the die 172 and cooperating with the die 172 to resect a tissue sample from the ear of the animal during articulation of the set of jaws 110 of the applicator 105 onto the ear of the animal.

### 1.1 Variation: Sensor-Activated Optical Detector

In one variation, the animal identification system 100 includes an applicator 105 including a set of jaws 110 including: a first jaw 112; and a second jaw 114 opposing the first jaw 112 and cooperating with the first jaw 112 to close over and to flatten a portion of an ear of an animal. In this variation, the applicator 105 also includes an optical emitter 140 arranged on the first jaw 112 and configured to emit light toward the second jaw 114 to illuminate the portion of the ear inserted between the first jaw 112 and the second jaw 114; an optical detector 145 coupled to the second jaw 114 and defining a field of view intersecting the optical emitter 140; and a sensor 116 coupled to the set of jaws 110 and configured to output a signal representing closure of the set of jaws 110 over the portion of the ear. In this variation, the animal identification system 100 also includes a controller 160 configured to trigger the optical detector 145 to capture an image of the portion of the ear, illuminated by the optical emitter 140, based on the signal.

### 2. Method

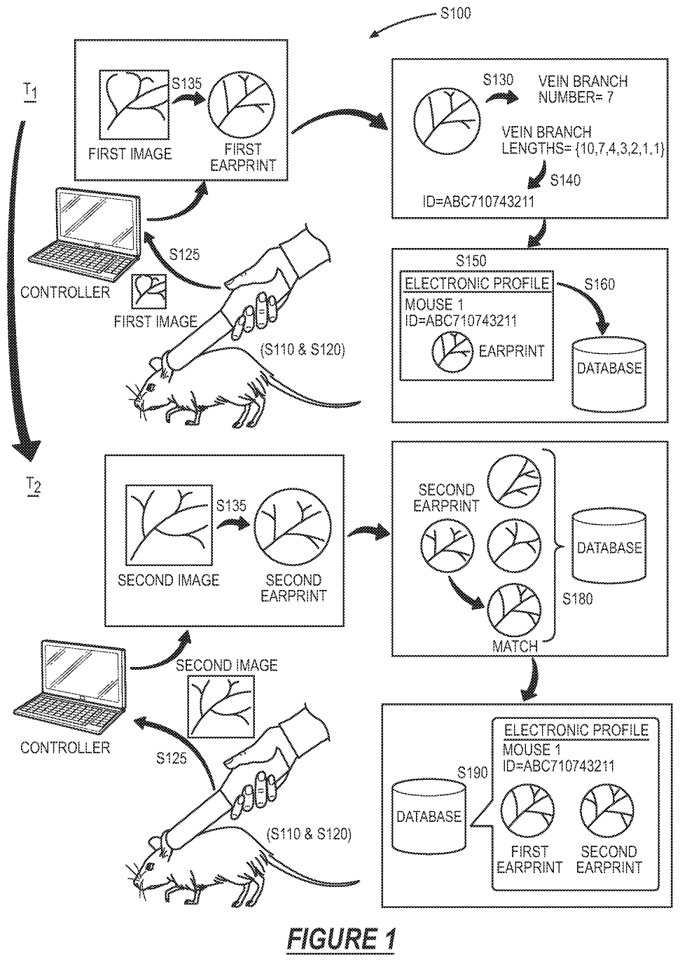

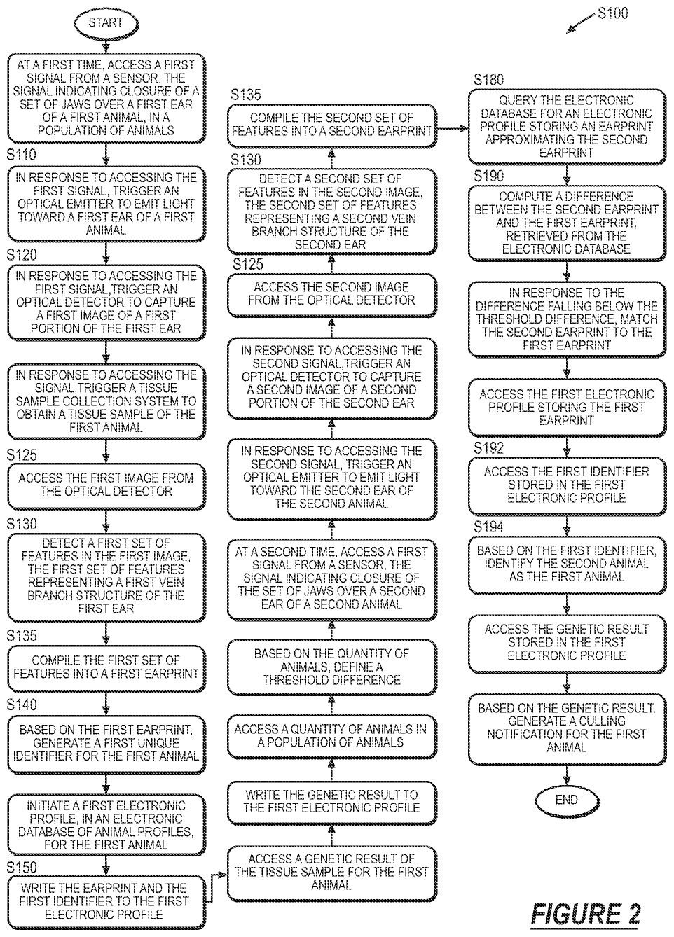

As shown in FIGS. 1-2, a method S100 for identifying animals includes: triggering the optical emitter 140 to illuminate an ear of a first animal at a first time during arrangement of the set of jaws 110 on the ear of the first animal in Block S110; triggering the optical detector 145 to capture a first image of the ear at the first time in Block S120; detecting a first set of features in the first image in Block S130, the first set of features representing a first vein branch structure (and/or ear edges, soft tissue features) of the ear of the first animal; compiling the first set of features into a first earprint of the first animal in Block S135, the first earprint uniquely identifying the first animal; writing the first earprint to a first electronic profile associated with the first animal in Block S150; and storing the first electronic profile in an electronic database in Block S160.

In one variation, the method S100 also includes: activating a tissue sample collection system 170 to retrieve a first tissue sample from the ear of the first animal (e.g., by extending an actuator 176 to drive the punch 174 into contact with the die 172 and resect the tissue sample from the ear of the animal) in Block S170; receiving a first genetic result associated with the first tissue sample in Block S172; and storing the first genetic result in the first electronic profile of the animal in Block S174.

In one variation, the method S100 further includes: triggering the optical emitter 140 to illuminate an ear of a second animal at a second time during arrangement of the set of jaws 110 on the ear of the second animal in Block S110; triggering the optical detector 145 to capture a second image of the ear at the second time in Block S120; detecting a second set of features in the second image in Block S130, the second set of features representing a second vein branch structure of the ear of the second animal; compiling the second set of features into a second earprint of the second animal in Block S135; querying the electronic database for an electronic profile containing an earprint matched to the second earprint in Block S180; and, in response to matching the second earprint to the first earprint contained in the first electronic profile, a) identifying the second animal as the first animal in Block S194 and b) retrieving genetic results, stored in the first electronic profile, for the second animal, in Block S198.

### 2.1 Variation: Initiating an Electronic Profile for an Earprint

In one variation, the method S100 for identifying animals includes, during closure of a set of jaws 110 over a first portion of a first ear of a first animal, in a population of animals, at a first time: triggering an optical emitter 140, arranged on a first jaw 112 of the set of jaws 110, to illuminate the first portion of the first ear in Block S110; and triggering an optical detector 145, arranged on a second jaw 114 of the set of jaws 110 opposite the optical emitter 140, to capture a first image of the first portion of the first ear in Block S120.

In this variation, the method S100 further includes: accessing the first image in Block S125; detecting a first set of features in the first image, the first set of features representing a first vein branch structure of the first ear in Block S130; compiling the first set of features into a first earprint of the first animal in Block S135, the first earprint uniquely identifying the first animal; associating the first earprint with a first identifier in Block S140; writing the first earprint and the first identifier to a first electronic profile of the first animal in Block S150; and storing the first electronic profile in an electronic database including a set of electronic profiles of the population of animals in Block S160.

### 2.2 Variation: Querying an Electronic Database for an Earprint

In one variation, the method S100 for identifying animals includes, during closure of a set of jaws 110 over an ear of an animal, in a population of animals: triggering an optical emitter 140, arranged on a first jaw 112 of the set of jaws 110, to illuminate a portion of the ear in Block S110; and triggering an optical detector 145, arranged on a second jaw 114 of the set of jaws 110 opposite the optical emitter 140, to capture an image of the portion of the ear in Block S120.

In this variation, the method for identifying animals further includes: accessing the image in Block S125; detecting a set of features in the image, the set of features representing a vein branch structure of the ear in Block S130; compiling the set of features into a first earprint of the animal, the first earprint uniquely identifying the animal in Block S135; querying an electronic database, including electronic profiles of the population of animals, for an electronic profile including a stored earprint approximating the first earprint in Block S180; and identifying a first electronic profile, in the electronic database, including the stored earprint approximating the first earprint in Block S190. The method S100 further includes, in response to identifying the first electronic profile: accessing a first identifier stored in the first electronic profile in Block S192; based on the first identifier, identifying the animal in Block S195; and associating the first earprint with the first electronic profile in Block S196.

### 3. Applications

Generally, the animal identification system 100 includes an applicator 105 (e.g., a mechanical applicator 105) and a software application configured to: transiently engage an ear of an animal (e.g., a lab mouse or other rodent), flatten or otherwise prepare the ear for imaging, capture an image of the ear, extract a set of features from the image, and define/determine a unique biometric identifier of the animal based on the set of features. In particular, the applicator 105 and the software application can capture an image of the ear of the animal, uniquely identify the animal based on a unique combination of features (e.g., vein branch pattern, number of vein branches, size of vein branches, geometry of vein branches) detected in the image, initialize an electronic record (e.g., a profile in a database) for the animal, associate the electronic record with the unique combination of features detected, and store the electronic record in a database of animal records.

Later, during a subsequent application of the applicator 105 onto the ear of the animal, the animal identification system 100 can be used to repeat the process of identification of an animal. In particular the animal identification system 100 can be applied to capture an image of an ear of an animal, uniquely identify the animal based on a unique combination of features (e.g., vein branch pattern, number of vein branches, size of vein branches, geometry of vein branches) detected in the image, query the database for the unique combination of features, and retrieve the electronic record exhibiting a best match of the unique combination of features. The controller 160 can therefore execute the method to uniquely identify an animal that is associated with an electronic record via a biometric marker, such as vain branch structure in an ear of an animal. More specifically, the controller 160 can execute the method to identify, with a relatively low risk of injury, relatively young animals (e.g., as young as 1 week old) that have small, fragile ears. Thus, the controller 160 can execute the method to rapidly identify groups of animals that are too young or too small for ear tagging and/or groups of animals for which manual permanent tagging (e.g., tail tattooing) is too time or labor intensive (e.g., time consuming, expensive). For example, ear tagging lab mice that are less than one week old is generally avoided as the ears of these mice are too small for tagging and it can injure the young mice. Meanwhile, the animal identification system 100 can be small enough to fit an ear of a mouse that is less than one week old and can be used for identification of the mouse without the risk of injury.

In the foregoing example, the animal identification system 100 can be operated by an operator, such as a lab technician, to biometrically identify young mice. During the initial stage of the identification process, the operator can restrain a mouse, apply the animal identification system 100 to generate an earprint of the mouse, and collect a tissue sample of the mouse. The operator may link the tissue sample to an identifier (e.g., identification number) of the mouse, (e.g., by placing the tissue sample in a vial labeled with the mouse identifier). The software application can then associate the mouse identifier with an earprint and store the earprint and the mouse identifier in an electronic profile of the mouse in a database. The operator may send the tissue sample to a laboratory for genetic testing. Once results of genetic testing are available, the software application can associate the genetic results of the mouse with the mouse identifier of the mouse and store the genetic results of the mouse in the electronic profile of the mouse.

Subsequent applications of the animal identification system 100 can be used to identify mice exhibiting a target genetic characteristic. During the subsequent stage of the process, the operator can restrain a second mouse and apply the animal identification system 100 to generate a second earprint. The operator may then utilize the software application to query the database for a stored target earprint that matches the second earprint. In response to identifying the target earprint corresponding to the second earprint, the software application can generate a confirmation notification. The software application can access the genetic result associated with the target earprint and, in response to the genetic result (e.g., a set of genetic characteristics) excluding the target genetic characteristic, generate a culling notification for the mouse.

Generally, the animal identification system 100 and method described herein can be used for biometric identification of young lab mice, such as between three and 30 days of age. However, the animal identification system 100 and method described herein may also be used for biometric identification of other animals and animals of other age ranges.

### 4. Applicator

Generally, the system 100 for biometric animal identification includes an applicator 105 including a set of jaws 110 including: a first jaw 112; and a second jaw 114 opposing the first jaw 112 and cooperating with the first jaw 112 to close over and to flatten a portion of an ear of an animal. In addition, the applicator 105 includes: an optical emitter 140: arranged on the first jaw 112 and configured to emit light toward the second jaw 114 to illuminate the portion of the ear inserted between the first jaw 112 and the second jaw 114; and an optical detector 145 coupled to the second jaw 114 and defining a field of view intersecting the optical emitter 140. In addition, the system 100 also includes a controller 160 configured to trigger the optical detector 145 to capture an image of the portion of the ear of the animal. Therefore, the system 100 for biometric animal identification includes the applicator 105, such as a mechanical device, configured to: illuminate the portion of the ear, revealing a vein branch pattern of the ear; and capture the image of the portion of the ear, which is illuminated.

### 4.1 Set of Jaws

Generally, the applicator 105 includes a set of jaws 110, such as opposing jaws, including: a first jaw 112; and a second jaw 114 opposing the first jaw 112 and cooperating with the first jaw 112 to close over and to flatten a portion of an ear of an animal. Therefore, the set of jaws 110 can close over the ear of the animal, flattening the ear of the animal and enabling an optical emitter 140 to illuminate the ear of the animal and its vein pattern and enabling an optical detector 145 to capture images of the ear of the animal.

In one implementation, the set of jaws 110 can include opposing jaws, configured to be manipulated by an operator to grip an ear of the animal. More specifically the set of jaws 110 can include the first jaw 112 and the second jaw 114 attached at a handle 120. The set of jaws 110 can move toward each other and close around the ear of the animal when force is applied to the applicator 105 (e.g., due to the operator's hand gripping the applicator 105). The set of jaws 110 can also move away from each other, thus releasing the ear when the force (e.g., applied by the hand of the operator) is removed from the applicator 105. Accordingly, an applicator 105 can be found in an open configuration or a closed configuration. In the open configuration, the set of jaws 110 are over a threshold distance away. When the applicator 105 is in the open configuration, the applicator 105 can be positioned over the ear of the animal. In the closed configuration, a small gap remains between the set of jaws 110. In the closed configuration, the applicator 105 can be used to flatten the ear and capture the images of the ear of the animal. In one implementation, the applicator 105 includes a stop 130 that is affixed to one of the jaws. In the closed configuration of the set of jaws 110, the stop 130 ensures formation of the gap between the set of jaws 110.

The first jaw 112 of the set of jaws 110 can cooperate with the second jaw 114 to bind the ear of the animal. In particular, the first jaw 112 can move toward or away from the second jaw 114 along a jaw articulation path, which can be circular or linear depending on the mechanics and geometry of the set of jaws 110. The first jaw 112 can include optical components such as an optical emitter 140 that defines an illumination axis tangent to the jaw articulation path. The first jaw 112 can also include a portion of the tissue sample collection system 170 such as a punch 174.

The second jaw 114 of the set of jaws 110 can cooperate with the first jaw 112 to bind the ear of the animal. In particular, the second jaw 114 can move toward/away from the first jaw 112 along the jaw articulation path. The second jaw 114 can include optical components such as an optical detector 145 that definiens the detection axis, which aligns with the illumination axis in the closed configuration of the detector. The second jaw 114 can also include a portion of the tissue sample collection system 170, such as a die 172.

### 4.2 Handle

In one implementation, the applicator 105 can include a handle 120 configured to be held by the operator. In one implementation, the handle 120 can be attached to the set of jaws 110. The handle 120 can be configured to transfer force exerted by the hand of the operator to the jaws to mechanically open or close the set of jaws 110. In one implementation, the handle 120 can include a trigger 118, such as a push button, which can be used to trigger collection of the images and/or collection of the tissue sample.

### 4.3 Stop

In one implementation, the applicator 105 can include a stop 130 configured to prevent the first jaw 112 and the second jaw 114 from coming into contact during closure over the ear of the animal, thereby preventing the set of jaws 110 from pinching the ear of the animal. More specifically, when the set of jaws 110 is in the closed configuration, the stop 130 is configured to establish a gap between the first jaw 112 and the second jaw 114, the gap characterized by a gap size (e.g., length) approximating a width of the ear of the animal.

In one implementation, the stop 130 can be formed of a high-friction elastic material such as rubber. In one implementation, the stop 130 can be arranged on the first jaw 112 and contact the second jaw 114 during closure of the set of jaws 110 over the ear. Additionally, or alternatively, a first stop 130, arranged on the first jaw 112, is configured to contact a second stop 130, arranged on the second jaw 114, during closure of the set of jaws 110 over the ear.

In one implementation, the stop 130 can define a variable length to establish the gap with variable width between the first jaw 112 and the second jaw 114 during closure of the second jaws. For example, the stop 130 can include an actuator 176 configured to extend or retract lengthening or shortening gap between the set of jaws 110 when the set of jaws 110 are in the closed configuration. In response to extension of the actuator 176, the stop 130 lengthens, increasing the gap between the set of jaws 110 and configuring the set of jaws 110 for application to ears of older or larger animals. In response to retraction of the actuator 176, the stop 130 shortens, decreasing the gap between the set of jaws 110 and configuring the set of jaws 110 for application to ears of younger or smaller animals. In another example, a set of stops of various sizes can each transiently couple to the set of jaws 110. In this example, the operator can: select, from the set of stops, a first stop corresponding to a target gap size; and install the first stop on the set of jaws 110 to establish the gap approximating the target gap size, such as the width of the ear of the animal. Therefore, by adjusting the length of the stop 130, the operator can adjust the size of the gap between the set of jaws 110 ensuring that the set of jaws 110 can flatten the ear for imaging without pinching or exerting excessive force onto the ear.

### 4.4 Sensor

In one implementation, the applicator 105 can include a sensor 116 affixed to one of the set of jaws 110, the stop 130, or elsewhere on the applicator 105. In response to receiving a signal from the sensor 116, the controller 160 of the animal identification system 100 can trigger the optical detector 145 to capture an image of the ear of the animal. More specifically, the applicator 105 can include the sensor 116 coupled to the set of jaws 110 and configured to output a signal representing closure of the set of jaws 110 over a portion of the ear of the animal. Based on the signal from the sensor 116, the controller 160 can trigger the optical detector 145 to capture an image of the portion of the ear illuminated by the optical emitter 140.

In one example, the sensor 116 can be a tactile pressure sensor arranged on the stop 130. This sensor 116 can detect when the stop 130 comes into contact with the opposing jaw and thus indicate when the set of jaws 110 are in the closed configuration. Based on the signal received from the sensor 116, the signal indicating that the applicator 105 is in the closed configuration, the controller 160 can trigger collection of the images.

In one implementation, in response to accessing the signal from the sensor 116, the controller 160 can trigger the tissue sample collection system 170 to extract a tissue sample from the ear of the animal. In particular, the controller 160 can trigger the tissue sample collection system 170 to extract the tissue sample in response to accessing the sensor signal indicating that the set of jaws 110 have been released from the closed configuration. In one example, the sensor 116 can include a photosensor arranged on the stop 130 and configured to be covered when the set of jaws 110 are in the closed configuration. In response to detecting light, the photosensor can output the signal, which indicates that the set of jaws 110 have been released from the closed configuration. In response to accessing the signal, the controller 160 can trigger the tissue sample collection system 170 to collect the tissue sample.

Additionally, or alternatively, the applicator 105 can include a trigger 118, such as a push button, which can trigger the image collection and/or the tissue sample collection. For example, the trigger 118 can be: arranged proximal the handle 120; and communicatively coupled to the controller 160. The controller 160 can: receive a signal from the trigger 118 indicating the activation of the trigger 118; and trigger the tissue sample collection system 170 to collect the tissue sample or the optical detector 145 to capture the image.

### 4.5 Optical Components

Generally, the animal identification system 100 can include a set of optical components, such as an optical emitter 140, a light pipe 148, a lens 150, a filter 146, and an optical detector 145, arranged on the set of jaws 110 and configured to: flatten the ear inserted between the set of jaws 110; illuminate the ear for imaging; and capture images of the ear. In one example, the applicator 105 can include: the optical emitter 140 arranged on the first jaw 112 and configured to emit light toward the second jaw 114 to illuminate the portion of the ear inserted between the first jaw 112 and the second jaw 114; and the optical detector 145 coupled to the second jaw 114 and defining a field of view intersecting the optical emitter 140.

In one implementation, the applicator 105 can include an optical emitter 140, such as a light emitting diode (hereinafter, LED), configured to emit light to illuminate the ear of the animal reveal a vein branch structure of the ear. In one implementation, the optical emitter 140 can include one or more LEDs. For example, the optical emitter 140 can include two LEDs, each LED configured to emit a light of a different wavelength. In this implementation, the optical emitter 140 can be configured to alternate the wavelength of emitted light by alternatively turning on/off various LEDs.

In one implementation, the optical emitter 140 can be configured to emit the light continuously when the set of jaws 110 are in the closed configuration. Additionally, or alternatively, the optical emitter 140 can be configured to emit light when the applicator 105 is in the open configuration, enabling the operator to view the vein branch structure of the ear and to position the applicator 105 over the portion of the ear where the vein branch structure is most visible.

In one implementation, the applicator 105 can include an optical filter 146: arranged on the set of jaws 110 proximal the optical emitter 140; and configured to absorb certain wavelengths of light emitted by the optical emitter 140.

In one implementation, the applicator 105 can include a light pipe 148, such as a prism or an optical fiber, configured to transmit light emitted by the optical emitter 140 toward the ear of the animal. For example, the light pipe 148 can be configured to bend the light emitted by the optical emitter 140 to direct it onto a focal plane of the ear inserted between the set of jaws 110. When the set of jaws 110 are in the closed configuration, the light pipe 148 can come into contact with the ear of the animal, thus flattening and smoothing the ear for imaging.

Additionally, or alternatively, the applicator 105 can include a lens 150 configured to focus or diffuse the light emitted by the optical emitter 140. In one implementation, when the set of jaws 110 are in the closed configuration, the lens 150 can come into contact with the ear of the animal, thus flattening and smoothing the ear for imaging. For example, the lens 150 can be: arranged on the second jaw 114 facing the optical emitter 140; and configured to direct light emitted by the optical emitter 140 toward the ear.

In one implementation, the applicator 105 can include a mirror 152:

arranged on the first jaw 112 of the set of jaws 110 and configured to deflect light emitted from the optical emitter 140 toward the ear of the animal. Additionally, or alternatively, the applicator 105 can include a mirror 152-such as a second mirror-arranged on the second jaw 114 of the set of jaws 110 and configured to adjust the field of view of the optical detector 145 by deflecting light passing though the ear of the ear of the animal toward the optical detector 145.

Furthermore, the applicator 105 can include an optical detector 145 defining a field of view intersecting the optical emitter 140 and configured to capture an image of the ear inserted between the first jaw 112 and the second jaw 114. For example, the optical detector 145 can: couple to the second jaw 114; and define a field of view intersecting the optical emitter 140. More specifically, the optical detector 145 can detect light emitted by the optical emitter 140 and passing though the ear. In one example, the optical detector 145 can include a short fixed focal length image sensor.

In one implementation, the optical detector 145 can capture a set of images or a video of the ear. Then, the controller 160 can compile the set of images into a single image characterized by a resolution exceeding the resolution of the set of images. In addition, the controller 160 can sample the video to retrieve a frame depicting features of the ear characterized by a target contrast, sharpness, or feature visibility. In this implementation, by capturing and processing the set of images or the video of the ear, the controller 160 and the optical detector 145 cooperate to ensure that the ear vein pattern is clearly visible in the captured image.

In one implementation, the optical emitter 140 can be arranged on the first jaw 112 and the optical detector 145 can be arranged on the second jaw 114 facing the optical emitter 140 and defining a field of view intersecting the optical emitter 140. Alternatively, the optical detector 145 can be arranged on the second jaw 114 facing the mirror 152 or another optical component configured to deflect light emitted from the optical emitter 140 and passing through the ear. Therefore, the optical detector 145 and the optical emitter 140 can cooperate to: transmit light though the ear, thereby illuminating the ear vein pattern of the ear; and capture an image of the ear, the image depicting the ear vein pattern.

In one implementation, the optical component that comes in contact with the ear of the animal during articulation of the set of jaws 110 over the ear, such as the lens 150, can include a low-friction surface. Thus, the optical component can flatten the ear without stretching, pulling, otherwise retaining, or damaging the ear if the animal were to suddenly move. In one example, the optical component can include a lubricated surface configured to permit the ear to slide against the optical component. In another example, the optical component can include low-friction optically transparent coating, which permits the optical component to glide against the ear. Therefore, the low-friction surface of the optical component enables the optical component to flatten the ear for imaging and release the ear if the animal were to move, thereby preventing damage to the ear.

### 4.5.1 Remote Optical Component Configuration

In one implementation, shown in FIG. 6, the animal identification system 100 includes: the optical emitter 140 arranged on the first handle 120; the optical detector 145 arranged on the second handle 120; a first light pipe 148 arranged on the first jaw 112, configured to face the ear inserted between the first jaw 112 and the second jaw 114, and coupled to the optical emitter 140 via a first optical cable; and a second light pipe 148 arranged on the second jaw 114, configured to face the ear inserted between the first jaw 112 and the second jaw 114, and coupled to the optical detector 145 via a second optical cable.

In one implementation, the first light pipe 148 is configured to: receive light from the first optical cable parallel to the first sagittal axis of the first jaw 112 and project light toward the second jaw 114 along a longitudinal axis (e.g., detection axis) perpendicular to the first sagittal axis. In this implementation, the second light pipe 148 is configured to: receive light passing through the ear along the longitudinal axis and output the light to the optical detector 145 via the second optical cable along a second sagittal axis perpendicular to the longitudinal axis. In another implementation, instead of the second light pipe 148, the animal identification system 100 can include a mirror 152 arranged on the second jaw 114 and configured to deflect the light passing through the ear along the longitudinal axis toward the light detector.

In these implementations, the optical emitter 140 and the optical detector 145 can be arranged on the handle 120 of the applicator 105, rather than on the set of jaws 110, thereby reducing the mass, volume, and/or size of the distal end of the applicator 105. This can enable the operator to have better control over the positioning of the applicator 105, particularly when dealing with very small or young mice. Additionally, arranging the optical emitter 140 and the optical detector 145 on the handle 120, rather than on the set of jaws 110, reduces bulk at the distal end of the applicator 105, which allows for greater animal comfort and better visual access to distal end of applicator 105 for the operator.

### 4.6 Tissue Sample Collection System

Generally, the applicator 105 can include a tissue sample collection system 170 configured to collect a tissue sample from the ear of the animal during articulation of the set of jaws 110 over the ear. Therefore, in addition to capturing an image of the ear to biometrically identify the animal, the animal identification system 100 can: collect the tissue sample from the ear to enable the operator to identify a genotype of the animal based on the tissue sample.

In one implementation, the tissue sample collection system 170 can include a die 172 affixed to the first jaw 112 (e.g., upper jaw) and a punch 174 affixed to the second jaw 114 (e.g., lower jaw). The punch 174 can cooperate with the die 172 to resect a tissue sample from the ear. In particular, during closing of the set of jaws 110 around the ear of the animal, the die 172 and the punch 174 can close around a small portion of the ear such that the die 172 and the punch 174 come into contact, thus resecting the small portion of the ear. The die 172 and the punch 174 can then be released from the closed configuration to precede any potential movement response of the animal).

In one implementation, the tissue sample collection system 170 can include an actuator 176 affixed to the punch 174, the die 172, or both. The actuator 176 can be configured to extend, bringing the punch 174 and the die 172 into contact and triggering the punch 174 and the die 172 to cooperatively resect the tissue sample. For example, the actuator 176 can extend in response to an indication that the applicator 105 was released from a closed configuration. In another implementation, the tissue sample collection system 170 can include another mechanism that can be configured to bring the punch 174 and the die 172 into contact. For example, the other mechanism can bring the punch 174 and the die 172 into contact in response to a force applied by the operator.

In one implementation, the applicator 105 can include: the punch 174 and the die 172 both arranged on the second jaw 114 (e.g., lower jaw); and the actuator 176 arranged on the first jaw 112 (e.g., upper jaw). In this implementation, the actuator 176 is configured to extend, thereby pushing the punch 174 toward the die 172 and bringing the punch 174 and the die 172 in contact. Therefore, in response to extension of the actuator 176, the punch 174 and the die 172 can linearly close about a portion of the ear, resecting the portion of the ear. In this implementation, the linear closure of the punch 174 and the die 172 ensures precise alignment of the punch 174 and the die 172 during the resection of the tissue sample, which may reduce the discomfort of the animal during the tissue sample collection.

The tissue sample collection system 170 can include a vial configured to receive the tissue sample resected by the die 172 and punch 174. In one implementation, the vial can be positioned below the die 172 and punch 174 assembly such that the vial captures the tissue sample during the application of the applicator 105 onto the ear of the animal.

In one implementation, the tissue sample collection system 170 can also enable replacement of the vial containing the tissue sample with a new, empty vial. In this implementation, the tissue sample collection system 170 can include a vial holder configured to receive the replaceable vial. For example, the tissue sample collection system 170 can include: the vial holder arranged on the second jaw 114 proximal the punch 174, such as blow the punch 175 or behind the die 172; and replaceable vial transiently coupled to the vial holder, arranged below the die 172, and configured to receive the tissue sample resected from the ear. Therefore, the operator may utilize the tissue sample collection system 170 to: collect a first tissue sample of a first animal and store the first tissue sample in a first replaceable vial; and then, collect a second tissue sample of a second animal and store the second tissue sample in a second replaceable vial without needing to empty, clean, and re-install the first replaceable vial on the applicator 105.

In one implementation, the tissue sample collection system 170 can include a replaceable (e.g., single-use) punch 174 and die 172 assembly configured to transiently install on the set of jaws 110. In one example, the tissue sample collection system 170 can include: the punch 174 configured to magnetically or mechanically couple to a first mount arranged on the first jaw 112; and the die 172 configured to magnetically or mechanically couple to a second mount arranged opposite the first mount on the second jaw 114, such that the punch 174 and the die 172 close around a portion of the ear during closure of the set of jaws 110. In this implementation, during application of the tissue sample collection system 170 onto the ear, the replaceable punch 174 and die 172 can resect from the ear and retain a first tissue sample. Following collection of the first tissue sample, the operator may: remove and discard the punch 174; and store the first tissue sample, sealed in the die 172 or in a vial, for processing; or remove the first tissue sample from the die 172 and transfer it to another container for processing. Therefore, the operator may utilize the tissue sample collection system 170 to: collect a first tissue sample of a first animal; and then, collect a second tissue sample of a second animal without needing to sterilize the punch 174 and the die 172 between the two tissue collection events. Accordingly, the tissue sample collection system 170 can enable collection of each new tissue sample with a replaceable, sterile punch 174 and die 172 assembly.

In an implementation, the tissue sample collection system 170 can resect the tissue sample when the applicator 105 is positioned over the ear of the animal, but the optical components of the of the applicator 105 are not in contact with the ear (e.g., to avoid causing injury to the ear if the animal moves in response to tissue collection). For example, the tissue sample collection system 170 can resect the tissue sample shortly following the capture of the images of the ear during closure of the opposing jaws over the ear. In this implementation, the controller 160 can trigger the tissue sample collection system 170 to resect the tissue sample in response to an indication that the set of jaws 110 have been released from the closed configuration following capture of the image of the ear.

In yet another example, the controller 160 can trigger the tissue sample collection system 170 to resect the tissue sample in response to accessing a user input, indicating a request to collect the tissue sample, from the trigger 118.

In one implementation, the tissue sample collection system 170 can include a local controller 160, such as a processor arranged on the applicator 105, configured to trigger tissue collection in response accessing a signal, from a sensor 116, indicating that the set of jaws 110 are in a target (e.g., closed) configuration. More specifically, in response to accessing the signal, the local controller 160 can trigger the actuator 176 of the tissue sample collection system 170 to extend bringing the punch 174 and the die 172 in contact and causing the punch 174 and the die 172 to resect the tissue sample. In this implementation, the local controller 160 is communicatively coupled to the sensor 116 configured to output the signal indicating that the set of jaws 110 are in a closed configuration. Additionally, or alternatively, the local controller 160 can cause the actuator 176 to extend or retract in response to receiving a signal from the trigger 118, the signal indicating a request to collect the tissue sample.

### 4.7 User Feedback Mechanism

In one implementation, the animal identification system 100 can include a user feedback mechanism configured to provide feedback to the user, the feedback indicating: whether the animal has been successfully identified, whether the image collection is complete, and/or whether the tissue sample collection is complete.

In one implementation, the user feedback mechanism can include a second optical emitter, such as an LED or a set of LEDs, arranged on the applicator 105; defining a field of view directed outwardly toward the operator; and configured to emit light of one or more colors. In this implementation, the second optical emitter is configured to emit light in response to one of: a full closure of the set of jaws 110; a completion of image collection; a completion of tissue sample collection; a successful animal identification (e.g., high confidence of a match between a collected earprint and a target earprint); or an unsuccessful animal identification (e.g., high confidence of a match between a collected earprint and a target earprint). In one example, in response to the set of jaws 110 fully closing over the ear, the second optical emitter can emit a yellow light. In this example, in response to detecting full closure of the set of jaws 110, the sensor 116 can output a signal. Then, in response to detecting this signal, the controller 160 can trigger the second optical emitter to emit the yellow light. In another example, in response to a successful animal identification, the second optical emitter can emit a green light. In this example, in response to identifying, within the electronic database, an electronic profile including a target earprint approximating a currently collected earprint, the controller 160 can trigger the second optical emitter to emit the green light.

In one implementation, the user feedback mechanism can include a speaker, arranged on the applicator 105 and configured to emit auditory user feedback. In one example, in response to detecting a closure of the set of jaws 110 over the ear, the controller 160 can trigger the speaker to emit a first auditory sequence and, in response to receiving a confirmation of a successful animal identification, the controller 160 can trigger the speaker to emit a second auditory sequence.

In one implementation, the user feedback mechanism can include a vibrating motor, arranged on the applicator 105 and configured to produce vibro-tactile user feedback. In one example, in response to detecting a closure of the set of jaws 110 over the ear, the controller 160 can trigger the motor to emit a first vibro-tactile sequence and, in response to receiving a confirmation of a successful animal identification, the controller 160 can trigger the motor to emit a second vibro-tactile sequence. In one implementation, the applicator 105 can include several different feedback mechanisms, such as the vibrating motor, the speaker, and the optical emitter, which can be triggered to provide feedback concurrently or sequentially.

In one implementation, the user feedback mechanism can include a display: arranged in a work zone where the operator may preform animal identification, such as arranged proximal a housing of the population of animals. This display can provide visual feedback to the operator, such as images received from the optical detector 145, notifications, or information of the identified animals. In one example, the display can provide feedback indicating whether the animal is successfully identified based on its earprint. More specifically, in response to identifying an animal as the first animal based on a first earprint of the animal, the controller 160 can instruct the display to display information stored in an electronic profile of the first animal. For example, in response to identification of the animal as the first animal, the display can display: the identifier of the first animal; the genetic information of the first animal; the target earprint previously stored in the electronic profile; and the first earprint, which was used to identify the animal. Alternatively, in response to failing to identify an animal based on a first earprint, the controller 160 can instruct the display to display a notification indicating that the controller 160 failed to find a match for the first earprint in the electronic database.

In one implementation, the user feedback mechanism can provide user feedback indicating an image capture failure. For example, if the animal moves during image capture, the optical detector 145 can capture an image lacking sufficient clarity or resolution and the controller 160 can fail to extract an earprint from the image. In response to failing to extract the earprint from the image, the controller 160 can generate the notification indicating the image capture failure and transmit this notification to the display.

Therefore, the animal identification system 100 can include the user feedback mechanism, such as the second optical emitter, the speaker, the vibrating motor, and/or the display, configured to provide feedback to the operator, the feedback enabling the operator to utilize the applicator 105 to collect the earprint and the tissue sample of the animal.

### 4.8 Applicator Configuration Variation

In one implementation, shown in FIG. 8, the applicator 105 can include a handle 120 configured to be gripped by the user; a head 128 mounted on the handle 120; the optical emitter 140 configured to illuminate the ear of the animal; the optical detector 145 configured to capture an image of the ear of the animal; and a set of jaws 110 arranged on the head 128 and configured to retain and flatten a portion of an ear of an animal (e.g., in response to a signal from the controller 160). In one example, applicator 105 can include: an optical detector 145 arranged on the head 128; a first jaw 112 arranged proximal the head 128; and a second jaw 114 arranged opposite the head 128, opposing the first jaw 112, and cooperating with the first jaw 112 to flatten a portion of an ear of an animal normal to a field of view of the optical detector 145. In this example, the applicator 105 can further include an optical emitter 140 arranged on the second jaw 114 and configured to illuminate the portion of the ear. In this implementation, the applicator 105 can include a trigger 118, such as a push button, arranged on the handle 120, configured to trigger the closing of the set of jaws 110 and/or the image collection. In this implementation, the operator may apply the applicator to retain the ear of the animal and capture the image of the ear while pointing the head 128 of the applicator toward the ear.

### 5. Controller

The animal identification system 100 includes a controller 160 configured to: trigger the optical emitter 140 to illuminate the portion of the ear of the animal, the ear inserted between the set of jaws 110; and trigger the optical detector 145 to capture one or more images of the portion of the ear. The controller 160 is also configured to: access the image of the portion of the ear; detect a set of ear features in the image; based on the set of ear features, generate an earprint uniquely identifying the animal; and populate an electronic profile, associated with the animal, with the earprint. The controller 160 is further configured to: access a second image of the portion of the ear; detect a second set of ear features in a second image; based on the second set of ear features, generate a second earprint; match the second earprint and the earprint; and identify the second earprint as corresponding to the animal.

In one implementation, based on the first image captured by the optical detector 145, the controller 160 can detect an ear notch pattern of the ear of the animal; and based on the ear notch pattern, identify the animal. In one example, the operator may mark the animal by removing portions of the ear, via scissors or a punch, to create a unique ear notch pattern. More specifically, the operator may create the unique ear notch pattern characterized by a location, quantity, and size of the ear notches or holes. Then, the operator may capture the ear notch pattern via the applicator 105 and utilize the system 100 to re-identify the animal based on this ear notch pattern.

In this implementation, the controller 160 can: access a first image of the ear of the animal from the optical detector 145; detect a first set of features in the first image, the first set of features representing a first quantity of notches, a first set of notch locations, and a first set of notch sizes of the ear; based on the first set of features, generate the first ear notch pattern uniquely identifying the ear; and store the first ear notch pattern in the electronic profile of the animal. Subsequently, the controller 160 can: access a second image of the ear of the animal from the optical detector 145; based on the second image, generate the second ear notch pattern; match the second notch pattern to the first notch pattern stored in the electronic profile of the animal; and in response to matching the second notch pattern to the first notch pattern, identify the animal. Similarly, the controller can: detect and store a unique ear mark pattern tattooed onto the ear of the animal, the ear mark pattern characterized by location, size, and quantity of ear marks; and then, re-identify the animal based on this ear mark pattern. Therefore, the controller 160 can: detect an ear notch pattern or an ear mark pattern of an ear of an animal based on an image captured by the applicator 105; and identify the animal based on the ear notch pattern or the ear mark pattern.

In one implementation, the controller 160 can: access a first image depicting a housing identifier, such as a number, an alphanumeric sequence, or a barcode, of the housing (e.g., cage) of the animal; detect the housing identifier depicted in the first image; and, based on the housing identifier, access a set of electronic profiles of a population of animals housed within the housing associated with the housing identifier. Then, the controller 160 can: access a second image of the portion of an ear of a first animal; detect a set of ear features in the second image; based on the set of ear features, generate a first earprint uniquely identifying the first animal; match the first earprint to a second earprint stored in a first electronic profile in the set of electronic profiles; and, in response to matching the first earprint to the second earprint, identify the animal associated with the first electronic profile.

For example, at a first time, the operator may utilize the applicator 105 to capture the first image of the housing identifier displayed on a side of the cage of the population of animals. The controller 160 can then access the set of electronic profiles of the population of animals based on the housing identifier. After capturing the image of the housing identifier, the operator may manipulate the applicator 105 to capture an image of the ear of the first animal housed in the cage. The controller 160 can then: derive a first earprint of the first animal; and identify the first animal by matching the first earprint to the second earprint stored in one of the electronic profiles in the set of electronic profiles.

Therefore, by accessing the set of electronic profiles associated with the population of animals prior to initiating identification of an animal within the population of animals, the controller 160 can reduce a quantity of electronic profiles that the controller 160 can search through to identify a match for an earprint. Thus, the controller 160 can: limit the search space to the set of electronic profiles associated with the population of animals within a single cage; and reduce the computational cost of identifying the animal based on the earprint.

In one implementation, the controller 160 can include a wired and/or a wireless connection to the applicator 105. The wired and/or wireless connection can allow the controller 160 to receive input from the trigger 118, the sensor 116, and the optical detector 145 and to control the optical emitter 140 and the actuator 176.

In one implementation, the controller 160 can include a wired and/or a wireless connection to a device, such as a mobile device (e.g., smartphone, tablet), including a camera. In this implementation, the controller 160 can access and process images of the animal captured by the device to identify the animal. In one example, the operator may utilize the device to capture an image of the ear of the animal. The controller 160 can: access this image; detect a set of features of the ear of the animal in the image, the set of features representing the vein branch structure of the ear; compile the set of features into an earprint of the animal; and based on the earprint, identify the animal within a population of animals. Therefore, the controller 160 can identify the animal based on images captured by any device.

In another example, the operator may utilize the device to capture an image of the whole animal. The controller 160 can: access this image; detect a set of features of the animal in the image, the set of features representing unique animal characteristics such as coat patterns of body morphologies; compile the set of features into a unique characterization of the animal; and, based on this unique characterization, identify the animal within a population of animals. Therefore, the controller 160 can identify the animal based on biometric features of the animal, such as coat patterns or body morphologies of the animal.

In one implementation, the controller 160 can include a wired/wireless connection to the display, such as an external monitor, arranged within the animal identification work zone. The controller 160 can be configured to display, via the display, the images collected by the optical detector 145, the earprint generated by the controller 160, and/or the animal data associated with the profile of the animal.

In one implementation, the controller 160 can include a wired and/or wireless connection to a user interface, such as a keyboard, or remote, or a touch screen. The controller 160 can receive input from the operator via the user interface. For example, the controller 160 can receive, via the user interface, instructions to deactivate tissue sample collection system 170 prior to the second application of the system. In another example, the controller 160 can receive, via the user interface, instructions to cause the optical detector 145 to collect 10 images 1 millisecond apart during the image collection.

### 6. Biometric Animal Identification

Generally, the method S100 for animal identification can be executed by the controller 160 to, during an initial time period: trigger the optical emitter 140 and the optical detector 145, arranged on the applicator 105, to illuminate the ear of the animal and capture an initial image of the ear; process the initial image to extract an initial earprint of the ear; initiate an electronic profile, in an electronic database of animal profiles, for the animal; and store the initial earprint in the electronic profile as a target earprint for the animal. In addition, the method S100 for animal identification can be executed by the controller 160 to, during a subsequent time period: trigger the optical emitter 140 and the optical detector 145 to illuminate an ear of an unidentified animal and capture a second image of the ear; access a second image; extract a second earprint based on the second image; and query the electronic database for the electronic profile including the target earprint approximating the second earprint to identify the animal. Furthermore, the method S100 for animal identification can be executed by the controller 160 to identify the unidentified animal as the animal based on detecting a match between the target earprint and the second earprint.

### 6.1 Initial Image Capture

Blocks S110 and S120 of the method S100 recite, at a first time and during closure of the set of jaws 110 over a first portion of a first ear of a first animal, in a population of animals: triggering the optical emitter 140, arranged on a first jaw 112 of the set of jaws 110, to illuminate the first portion of the first ear; and triggering the optical detector 145, arranged on a second jaw 114 of the set of jaws 110 opposite the optical emitter 140, to capture a first image of the first portion of the first ear. Generally, in Blocks S110 and S120, the controller 160 can activate the optical emitter 140 to illuminate the first portion of the first ear and activate the optical detector 145 to capture the first image of the first portion of the first ear. Therefore, the controller 160 can capture the first image of the first portion of the ear, illuminated by light emitted from the optical emitter 140, and displaying the ear vein structure of the first ear of the first animal, which is unique to the animal.

In one implementation, the controller 160 can concurrently trigger: the optical detector 145 to collect a set of images of the first ear of the first animal; and cause the optical emitter 140 to emit light. For example, the controller 160 can trigger the optical emitter 140 to emit light in response to receiving user input from a trigger 118 or in response to accessing a sensor signal indicating closure of the set of jaws 110. If the optical emitter 140 includes a set of LEDs, the controller 160 can activate different LEDs in sequence to emit light of different wavelengths at different times. During activation of the optical emitter 140, the controller 160 can trigger the optical detector 145 to capture the set images of the first ear. In one example, the controller 160 can activate the optical detector 145 to capture the set of images at a particular sampling rate, such as 20 frames per second.

In one implementation, based on a quantity of animals, the controller 160 can derive a first set of dimensions (e.g., diameter, or length and width) of the first portion of the first ear to be captured by the optical detector 145. Then, the controller 160 can trigger the optical detector 145 to capture the first image of the first region of the first ear, the first region characterized by the first set of dimensions. In one implementation, to trigger the optical detector 145 to capture the first image of the first region, characterized by the first set of dimensions, the controller 160 can trigger an actuator 176, coupled to the optical detector 145, to translate the optical detector 145 vertically or laterally relative to the second jaw 114 to adjust the distance between the optical detector 145 and the first ear, thereby adjusting the size or area of the first region captured by the optical detector 145. Therefore, by adjusting the size of the first region of the first ear, captured in the first image, the controller 160 can: increase or decrease the feature count of the first vein branch pattern, depicted in the first image; and, thereby, increase the specificity or uniqueness of the first earprint, derived from the first image.

### 6.2 Tissue Sample Collection

In one implementation, at the first time, during closure of the set of jaws 110 over the first portion of the first ear, the controller 160 can trigger the tissue sample collection system 170, installed on the set of jaws 110, to resect a tissue sample from the first ear of the first animal. In one example, to collect the tissue sample, the controller 160 can trigger an actuator 176, affixed to one of the punch 174 or the die 172 of the tissue sample collection system 170, to extend bringing the punch 174 and the die 172 into contact and resecting the tissue sample. Therefore, in addition to capturing the first image of the first ear during closure of the set of jaws 110 over the first portion of the first ear, the controller 160 can also trigger retrieval of the tissue sample from the first ear, the tissue sample used to identify the genotype of the first animal.

In this implementation, the operator may retrieve the tissue sample from the tissue sample collection system 170 and provide the tissue sample to a laboratory for genetic testing. Following completion of the genetic testing, the controller 160 can access a first genetic result (e.g., genetic sequence) of the tissue sample and store the first genetic result in a first electronic profile of the first animal. For example, the controller 160 can query an external database of genetic results based on the unique identifier of the first animal to access the first genetic result associated with the unique identifier in the external database.

Therefore, during a single closure of the set of jaws 110 around the ear of the animal, the controller 160 can trigger concurrent image capture and tissue sample collection from the ear. Furthermore, the controller 160 can link both an earprint derived from the image and the tissue sample to the unique identifier of the animal. Then, following genetic testing of the tissue sample, the controller 160 can: access the genetic result of the tissue sample; link the genetic result to the unique identifier of the animal; and store the genetic result in the electronic profile of the animal.

### 6.3 First Earprint

Blocks S130 and S140 of the method S100 recite: detecting a first set of features in the first image, the first set of features representing a first vein branch structure of the first ear; and compiling the first set of features into a first earprint of the first animal, the first earprint uniquely identifying the first animal. Generally, in Blocks S130 and S140, the controller 160 can: access the first image from the optical detector 145; process the first image to extract the first set of features, such as a quantity of vein branches, vein branch lengths, and vein branch angles of the first vein branch structure depicted in the first image; and, based on the first set of features, generate the first earprint. Therefore, the controller 160 can process the first image to identify the first vein branch structure of the first ear and generate the first earprint, which is unique to the first animal and can be used to biometrically re-identify the first animal at a later time.

In one implementation, the controller 160 can set a target quantity of the features to detect in the first image based on a quantity of animals in the population of animals to ensure that each animal in the population of animals is uniquely identifiable based on the corresponding earprint of the animal. In this implementation, the controller 160 can: access a quantity of animals in the population of animals; and, based on the quantity of animals in the population of animals, derive a target feature count proportional to the quantity of animals. For example, the controller can: prompt the operator to enter, via the user interface, the quantity of animals in an animal population; and then, access the quantity of animals, such as a current or a maximum quantity of animals, entered by the operator. Then, the controller 160 can: detect the first set of features in the first image, the first set of features including a quantity of features corresponding to the target feature count. Generally, the target feature count specifies the uniqueness of each earprint, in a set of earprints, of the population of animals. Thus, to uniquely identify each animal within an animal population, the controller 160 can select a target feature count proportional to the quantity of animals in the population. However, to identify, in an image, an increasing target feature count, the controller 160 consumes an increasing amount of computational resources. For example, if the quantity of animals in the population of animals is within a first range, such as 100-500 animals, the controller 160 can: select a first target feature count, such as 50 features; and identify 50 features in the first image, and compile the 50 features into the first set of features. Thus, the controller 160 can ensure that the first earprint, derived from the first set of features, exhibits sufficient specificity or feature resolution to ensure uniqueness, in the set of earprints of the population of animals. However, if the quantity of animals in the population of animals is within a second range, such as 10-20 animals, the controller 160 can: select a second target feature count, such as five features, identify the five features in the first image, and compile the five features into the first set of features. Thus, the controller 160 can reduce the consumption of computational resources involved in identifying the first set of features in the first image. Therefore, based on the total quantity of animals in the animal population, the controller 160 can adjust the target feature count to derive, without excessive consumption of computational resources, a vein branch structure characterized by a target level of specificity and uniquely identifying the first animal in the population of animals.

In one implementation, the controller 160 can: receive the first image or a first set of images captured by the optical detector 145 at the first time; and pre-process the set of images to increase the visibility or detectability of the first set of features, representing the first vein branch structure, in the set of images. In one example, pre-processing the first images can include: removing noise and optical artifacts from the first images; translating the first to another color space, such as a red color space, a green color space, or a blue color space; and applying digital filters, such as a high pass filter, to the first image.

In one implementation, after pre-processing the set of images, the controller 160 can detect the first vein branch structure of the first ear depicted in the set of images. Detecting the first vein branch structure can include: identifying a first set of pixels of an image, in the set of images, that represent the veins of the first vein branch structure; and identifying a second set of pixels of the image that represent skin tissue of the first ear. For example, the controller 160 can identify the first set of pixels as the pixels representing the veins of the first vein branch structure in response to the first set of pixels, in the pre-processed first image, defining a color within a certain color range.

After identifying the first vein branch structure of the first ear, the controller 160 can generate the first earprint (e.g., target earprint) of the first ear based on the first vein branch structure and/or based on the first set of features. In one example, the first earprint can include a two-tone (e.g., black and white) image of the first vein branch structure of the first ear. In another example, the first earprint can include a vector image of the first vein branch structure of the first ear. Therefore, the controller 160 can generate the first earprint that can uniquely identify the first animal and can be used by the operator to re-identify the first animal based on a similarity of the first earprint to other earprints, collected at other times.

### 6.4 Initiating First Electronic Profile

Blocks S140, S150, and S160 of the method S100 recite: associating the first earprint with a first identifier; writing the first earprint and the first identifier to a first electronic profile of the first animal; and storing the first electronic profile in an electronic database including a set of electronic profiles of the population of animals. In Blocks S140, S150, and S160, the controller 160 can: link the first earprint to a first identifier, such as an alphanumeric code, of the first animal, the first identifier uniquely identifying the animal within the electronic database; initiate the first electronic profile for the first animal in the electronic database of animal profiles; and store the first earprint and the first identifier in the first electronic profile. Therefore, after generating the first earprint for the first animal for the first time, the controller 160 can initiate the first electronic profile for the first animal, the first electronic profile configured to contain identifying information of the first animal, such as earprints and the identifier of the first animal, and other information of the first animal, such as the genetic results of the first animal.

In one implementation, the controller 160 can associate the first earprint with the first identifier, which uniquely identifies the first animal in the population of animals. In one example, the first identifier can uniquely identify the first animal in a population of animals housed within a particular animal housing. In another example, the first identifier can uniquely identify the first animal in a population of animals bred at a particular breeding facility or a population of animals participating in a particular laboratory experiment. In one implementation, the first identifier of the first animal can include an identifying pattern, a color combination, or a code displayed on an ear tag affixed to the first ear of the animal. In one example, when the first animal is young, such as less than six weeks old, the operator may utilize the applicator 105 to identify the animal based on the earprint of the animal. Later, when the animal is older, such as more than six weeks old, the operator may affix the ear tag to the ear of the animal, the ear tag displaying the identifier associated with the earprint, and subsequently identify the animal based on the ear tag.

In one implementation, the controller 160 can generate the first identifier based on the earprint. For example, the controller 160 can generate the first identifier that includes a numeric representation of the earprint. More specifically, the controller 160 can, based on the first earprint, derive the first identifier by: identifying a set of characteristics of the first earprint including a quantity of branches of the first vein branch structure, angles between branches in the first vein branch structure, and lengths of branches of the first vein branch structure; and mapping the set of characteristics into a numeric code. In one implementation, the controller 160 can incorporate the numeric code into the unique identifier of the animal. In another implementation, the controller 160 can store the numeric code in the electronic profile of the animal (e.g., instead of the earprint of the animal), as the data size of the numeric code is less than the data size of the earprint. In this implementation, the controller 160 can link the first earprint and a second earprint to the first animal in response to a difference between the first numeric code and a second numeric code falling below a threshold.

Therefore, based on an earprint, the controller 160 can derive a numeric code that exclusively maps to the earprint and uniquely identifies the animal associated with the earprint. In addition, the controller 160 can store the numeric code in the electronic profile of the animal (e.g., instead of the earprint of the animal) to reduce the data size of the electronic profile. Furthermore, the controller 160 can compute differences between numeric codes (e.g., instead of computing differences between earprints) to reduce the computational resources associated with matching the earprint with an animal.

### 6.5 Subsequent Image Detection

Blocks S110 and S120 of the method S100 recite, at a second time, during closure of the set of jaws 110 over a second portion of a second ear of a second animal, in the population of animals: triggering the optical emitter 140 to illuminate the second portion of the second ear; and triggering the optical detector 145 to capture a second image of the second portion of the second ear. Generally, in Blocks S110 and S120, the controller 160 can: trigger the optical emitter 140 to illuminate the second ear of the second animal, which, at the second time, is unidentified; and capture the second image of second portion of the second ear, illuminated by the optical emitter 140. Therefore, at the second time, the controller 160 can: trigger the optical emitter 140 to illuminate the second ear to reveal the ear vein structure of the second ear; and trigger the optical detector 145 to capture the second image of this ear vein structure to identify the second animal.

In one implementation, at the second time, the controller 160 can trigger the optical detector 145 to illuminate the second ear and capture the second image (or a second set of images) of the second ear in response to receiving a signal from a sensor 116, the signal indicating closure of the set of jaws 110 over the ear of the animal. More specifically, at the second time, the controller 160 can access the signal from the sensor 116 (e.g., optical sensor, vibration sensor), the signal indicating closing of the set of jaws 110 over the second ear. Then, in response to accessing the signal, the controller 160 can: trigger the optical emitter 140 to illuminate the second portion of the second ear; and trigger the optical detector 145 to capture the second image of the second portion of the second ear. Therefore, the controller 160 can trigger capture of the second image during the closure of the set of jaws 110 over the second ear, when the second ear is flattened by the set of jaws 110 and illuminated by the optical emitter 140.

Similarly, at the second time, the controller 160 can trigger the optical detector 145 to capture the second image or a second set of images of the second ear in response to receiving a signal from the trigger 118, the signal indicating a user request to illuminate the second ear and capture the second image.

### 6.6 Generating Second Earprint

Blocks S125, S130, and S140 of the method S100 recite: accessing the second image from the optical detector 145; detecting a second set of features in the second image, the second set of features representing a second vein branch structure of the second ear; and compiling the second set of features into a second earprint of the second animal. Generally, in Blocks S125, S130, and S140, the controller 160 can: access the second image; process the second image to extract the second set of features, such as vein branches, vein branch lengths, and vein branch angles, of the second vain branch structure depicted in the second image; and, based on the second set of features, generate the second earprint. Therefore, the controller 160 can process the second image to identify the second vein branch structure of the second ear and generate the second earprint of the second animal to biometrically re-identify the first animal based on the second earprint.

Generally, to extract the second earprint from the second image at the second time, the controller 160 can apply the same processing techniques to the second image as the processing techniques applied to the first image at the first time to extract the first earprint. Furthermore, to ensure uniqueness of the second earprint, derived from the second set of features, in a set of earprints of the population of animals, the controller 160 can define the target feature count, in the second set of features, proportional to the quantity of animals in the population of animals. Then, the controller 160 can detect the second set of features, in the second image, including the target feature count.

In an example implementation, after pre-processing the second image and detecting the second vein branch structure, the controller 160 can generate the second earprint of the second ear. In one example, the second earprint can include a two-tone (e.g., black and white) raster image of the second vein branch structure of the second ear. In another example, the second earprint can include a vector image of the second vein branch structure of the second ear. Therefore, the controller 160 can generate the second earprint that, based on similarity, can be matched to another earprint, such as the first earprint, stored in the electronic database and can thus link the second animal to an electronic profile, stored in the electronic database, identifying the second animal.

### 6.7 Matching Second Earprint to an Electronic Profile

Blocks S180 and S190 of the method S100 recite: querying the electronic database for an electronic profile including an earprint approximating the second earprint; and identifying the first electronic profile, in the electronic database, including the first earprint approximating the second earprint. Generally, in Blocks S180 and S190, the controller 160 can: search the electronic database for an earprint matching or approximating the second earprint. For example, the controller 160 can sequentially access each electronic profile in the database and calculate a difference between the second earprint and the earprint stored in each electronic profile. Then, the controller 160 can select the earprint associated with a difference between the earprint and the second earprint, the difference falling below a threshold difference, as the second earprint. Therefore, by querying the electronic database for the earprint approximating the second earprint, the controller 160 can: identify the first electronic profile storing the earprint matching the second earprint of the second animal; and, based on information contained in the electronic profile, identify the second animal.

In one implementation, to match the second earprint with the first earprint, the controller 160 can: retrieve the first earprint from the first electronic profile; and characterize a first difference between the first set of ear features represented in the first earprint and the second set of ear features represented in the second earprint. More specifically, the controller 160 can: characterize the first difference between presence and spatial distribution of the first set of ear features represented in the first earprint and the second set of ear features represented in the second earprint. Then, in response to the first difference falling below a threshold difference, the controller 160 can: match the second earprint to the first earprint; and identify the second animal as the first animal. Therefore, the controller 160 can identify the second animal as the first animal based on the difference between the first earprint and the second earprint falling below a threshold difference (e.g., 10% difference), indicating that the first earprint approximates the second earprint. Accordingly, the controller can identify an animal based on a similarity between its currently captured earprint and a previously captured earprint.

In one example, the controller 160 can: calculate a difference between a first quantity of vein branches represented in the first earprint and a second quantity of vein branches represented in the second earprint; calculate a set of length differences between a first set of vein branches represented in the first earprint and a second set of vein branches represented in the second earprint; and calculate a set of angle differences of angles of the first set of vein branches represented in the first earprint and angles of the second set of vein branches represented in the second earprint. Then, based on the quantity difference the set of length differences, and the set of angle differences, the controller 160 can derive a first difference (e.g., average difference, difference score) representing the level of deviation between the first vein branch structure and the second vein branch structure. In response to the first difference falling below the threshold difference, the controller 160 can detect that the first earprint approximates the second earprint. Additionally, in response to the first difference exceeding the threshold difference, the controller 160 can detect that the first earprint does not approximate or match the second earprint. Therefore, the controller 160 can identify a similarity between two earprints based on differences in quantity of branches of the two earprints, lengths of branches of the two earprints, and/or angles of branches of the two earprints.

In one implementation, the controller 160 can apply a machine learning model to match the second earprint to the first earprint stored in the electronic database or a database of earprints. For example, the controller 160 can select a set of earprints (e.g., a set of possible matches) from the database of earprints and generate a set of confidence scores for each match between the second earprint and each earprint in the set of earprints, the confidence score indicating a level of similarity between the second earprint and the target earprint in the set of earprints. Thus, the controller 160 can identify the target earprint with the highest confidence score as a match for the second earprint. Furthermore, the controller 160 can train the machine learning model on a set of earprints, identified as earprints of the first animal, to classify newly captured earprints as either a) an earprint of the first animal or b) an earprint of another animal. Thus, the controller 160 can apply a machine learning model to classify the second earprint as a variation of the first earprint of the first animal.

### 6.7.1. Defining a Threshold Earprint Difference

In one implementation, the controller 160 can: calculate a predicted difference in spatial distribution of ear features represented in two earprints generated based on images of a single ear captured on a time interval corresponding to a time difference between the first time period and the second time period; and, based on the predicted difference, calculate a threshold difference for the first earprint. Then, in response to the first difference between the first set of ear features represented in the first earprint and the second set of ear features represented in the second earprint falling below the threshold difference, the controller 160 can match the second earprint to the first earprint. Therefore, the controller 160 can: define the threshold difference for earprints, the threshold difference specifying a minimum level of similarity between two earprints of the same ear captured at different times; and, based on the threshold difference, identify matches between two or more earprints of the same animal. Thus, the controller can match a first earprint of the first animal, captured when the first animal was two weeks old, with the second earprint of the first animal, captured when the first animal was 10 weeks old, despite differences between the first earprint and the second earprint caused by growth of the first animal.

In one implementation, the controller 160 can define the threshold difference based a rate of change of spatial distribution of ear features represented in two earprints generated based on images of a single ear, the rate of change representing repeatability of two earprints, of a single animal, collected at different times. In this implementation, in response to matching the second earprint to the first earprint during a second time period, the controller 160 can: calculate the rate of change of spatial distribution of ear features represented in two earprints of a single ear based on the first earprint and the second earprint. Then, during a third time period succeeding the second time period, the controller 160 can: based on the rate of change and a time interval between the third time period and the second time period, calculate a second threshold difference; capture a third image (i.e., new image) of the third portion of the third ear of a third animal; detect a third set of features in the third image; compile the third set of features into a third earprint of the third animal; and characterize a third difference between the third set of ear features represented in the third earprint and a first set of ear features represented in the first earprint. Then, in response to the third difference falling below the second threshold difference, the controller 160 can match the third earprint to the first earprint. Therefore, the controller 160 can: calculate the rate of change of spatial distribution of ear features represented in earprints of a single ear; and, based on this rate of change and a time interval between two consecutive earprint captures, calculate the threshold for identifying two earprints of the same animal.

In one implementation, based on the rate of change of the earprint of a single animal, the controller 160 can generate a predicted earprint for the first animal at a third time and utilize the predicted earprint to identify the first animal at the third time. In this implementation, the controller 160 can: based on the first earprint and the second earprint, calculate rate of change of spatial distribution of ear features represented in two earprints generated based on images of a single ear. Then, during a third time period succeeding the second time period, the controller 160 can: based on the rate of change and a time interval between the third time period and the second time period, generate a fourth ear print of the first animal; access a third image of the third portion of the third ear; detect a third set of features in the third image; compile the third set of features into a third earprint of the third animal; characterize a third difference between the third set of ear features represented in the third earprint and a fourth set of ear features represented in the fourth earprint; and, in response to the third difference falling below a threshold difference, match the fourth earprint to the third earprint and identify the third animal as the first animal. Therefore, the controller 160 can: generate a predicted earprint (e.g., fourth earprint) representing an earprint that the animal is predicted to have at a at a third (e.g., future) time given the rate of change of spatial distribution of ear features of earprints of the animal's single ear; and, based on the predicted earprint, identify the animal at the third (e.g., future) time.

In one implementation, the controller 160 can define the threshold difference based on a quantity of animals in the population of animals, the quantity of animals proportional to a quantity of unique identifiers, such as unique earprints, of each animal in the population of animals. In one example, in response to detecting a first quantity of animals in the population of animals, such as 10 animals (e.g., a relatively low quantity), the controller 160 can define a first threshold difference, such as a 10% difference (e.g., a relatively high threshold difference), for identifying two earprints of a single animal, as two animals in this population are unlikely to have similar earprints. In another example, in response to detecting a second quantity of animals in the population of animals, such as 500 animals (e.g., a relatively high quantity), the controller 160 can define a second threshold difference, such as a 1% difference (e.g., a relatively low threshold difference), for identifying two earprints of a single animal, as two animals in this population may have similar earprints. Therefore, the controller 160 can define the threshold difference based on the quantity of animals in the population of animals to ensure that each animal in the population of animals is associated with an earprint that distinguishes the animal from other animals in the population.

### 6.8 Identifying the Second Animal

Blocks S192, S194, and S196 of the method S100 recite, in response to identifying the first electronic profile: accessing the first identifier stored in the first electronic profile; based on the first identifier, identifying the second animal as the first animal; and associating the second earprint with the first electronic profile. Generally, in Blocks S192, S194, and S196, the controller 160 can identify the second animal as the first animal based on the first electronic profile, and, more specifically, based on the first identifier of the first animal stored in the electronic profile. Additionally, or alternatively, the controller 160 can identify the second animal as the first animal based on the first earprint, stored in the first electronic profile and, more specifically, based on the second earprint matching the first earprint. In addition, after identifying the second animal as the first animal, the controller 160 can optionally store the second earprint in the first electronic profile. Therefore, the controller 160 can: identify the second animal based on the second earprint matching the first earprint; link the identified animal with the first electronic profile; and, optionally, write the second earprint to the first electronic profile.

In one implementation, in response to identifying the second animal as the first animal and matching the second earprint with the first earprint, the controller 160 can update the first earprint stored in the first electronic profile by: generating a combined earprint combining the first earprint and the second earprint; writing the combined earprint to the first electronic profile; and generating a combined set of ear features, corresponding to the combined earprint, defining a combination of the first set of ear features and the second set of ear features. In one example, the controller 160 can generate the combined earprint by calculating a spatial average of the first earprint and the second earprint. Therefore, by generating and storing the combined earprint in the first electronic profile, the controller 160 can: avoid storing multiple earprints captured at different times in the first electronic profile; and update the earprint, associated with the first animal and stored in the first electronic profile, as the first animal grows, and the first vein branch structure changes.

In this implementation, during a third time period succeeding the second time period, the controller 160 can identify the first animal at a third time based on the combined earprint. More specifically, during the third time period, the controller 160 can: access a third image of the third portion of the third ear; detect a third set of features in the third image, the third set of features representing a third vein branch structure of the third ear; compile the third set of features into a third earprint of the third animal; retrieve the combined earprint from the first electronic profile; and characterize a third difference between the third set of ear features represented in the third earprint and the combined set of ear features represented in the combined earprint. Then, in response to the third difference falling below a threshold difference, the controller 160 can: match the combined earprint to the third earprint; and identify the third animal as the first animal. Therefore, the controller 160 can update the earprint associated with the first animal by generating a combined earprint based on several earprints of the first animal collected at different times, which can be more representative (e.g., have a lower difference with) the vein branch structure of the first ear of the first animal than an individual earprint. Then, the controller 160 can identify the first animal at subsequent times based on the combined earprint.

In one implementation, once the second earprint has been matched to the first earprint, the controller 160 can execute an operation based on the first electronic profile associated with the first earprint. For example, the controller 160 can display information included in the first electronic profile on the display arranged proximal the animal identification work zone. In another example, the controller 160 can query the first electronic profile to identify a target genetic trait, stored in the first electronic profile, and generate a culling notification for the animal in response to identifying the target genetic trait in the first electronic profile. In another example, in response to identifying a second animal as the first animal, the controller 160 can: retrieve the first identifier from the first electronic profile; and present the first identifier via a user interface. Therefore, in response to identifying a second animal as the first animal, the controller 160 can retrieve the information, such as the genetic results, the earprint, and/or the identifier of the first animal, stored within the electronic profile of the first animal, and present this information to the operator.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. An animal identification system comprises:
an applicator comprising:
a set of jaws comprising:
a first jaw; and
a second jaw:
opposing the first jaw; and
cooperating with the first jaw to close over and to flatten a portion of an ear of an animal;
an optical emitter:
arranged on the first jaw; and
configured to emit light toward the second jaw to illuminate the portion of the ear inserted between the first jaw and the second jaw;
an optical detector:
coupled to the second jaw; and
defining a field of view intersecting the optical emitter;
a sensor:
coupled to the set of jaws; and
configured to output a signal representing closure of the set of jaws over the portion of the ear; and
a controller configured to trigger the optical detector to capture an image of the portion of the ear, illuminated by the optical emitter, based on the signal.

2. The animal identification system of claim 1, further comprising:
a lens:
arranged on the second jaw;
facing the optical emitter; and
configured to direct light emitted by the optical emitter toward the ear.

3. The animal identification system of claim 1, further comprising:
a handle configured to close the set of jaws along a jaw articulation path; and
a stop:
interposed between the first jaw and the second jaw; and
configured to prevent the set of jaws from impinging the portion of the ear.

4. The animal identification system of claim 1:
further comprising a handle configured to close the set of jaws along a jaw articulation path;
wherein the optical emitter is configured to emit light toward the second jaw perpendicular to the articulation path;
wherein the optical detector defines a focus axis perpendicular to the articulation path;
further comprising:
a light pipe:
arranged adjacent the optical emitter; and
configured to direct light, emitted by the optical emitter perpendicular to the articulation path, along the articulation path toward the portion of the ear;
a mirror:
arranged adjacent the optical detector; and
configured to redirect light, directed along the articulation path and through the ear by the light pipe, toward the optical detector.

5. The animal identification system of claim 1, wherein the controller is further configured to:
access the image of the portion of the ear;
detect a set of ear features in the image;
based on the set of ear features, generate an earprint uniquely identifying the animal; and
populate an electronic profile, associated with the animal, with the earprint.

6. The animal identification system of claim 5, wherein the controller is further configured to:
detect a second set of ear features in a second image captured by the optical detector;
based on the second set of ear features, generate a second earprint;
retrieve the earprint from the electronic profile;
characterize a difference between presence and spatial distribution of the set of ear features represented in the earprint and the second set of ear features represented in the second earprint; and
in response to the difference falling below a threshold difference:
match the second earprint and the earprint; and
identify the second earprint as corresponding to the animal.

7. The animal identification system of claim 1, further comprising:
a tissue sample collection system comprising:
a die arranged on the first jaw; and
a punch:
arranged on the second jaw opposite the die; and
configured to cooperate with the die to resect a tissue sample from the ear during closure of the set of jaws onto the portion of the ear.

8. The animal identification system of claim 7, wherein the tissue sample collection system is configured to transiently install on the set of jaws.

9. The animal identification system of claim 7, wherein the tissue sample collection system further comprises:
a vial holder arranged on the second jaw behind the die; and
a replaceable vial:
transiently coupled to the vial holder;
arranged below the die; and
configured to receive the tissue sample resected from the ear.

10. The animal identification system of claim 7:
wherein the tissue sample collection system further comprises an actuator affixed to one of the punch and the die; and
wherein the controller is configured to trigger the actuator to drive the punch toward the die to resect the tissue sample from the ear during closure of the set of jaws onto the portion of the ear.

11. A method for identifying animals comprising:
during a first time period:
during closure of a set of jaws over a first portion of a first ear of a first animal, in a population of animals:
triggering an optical emitter, arranged on a first jaw of the set of jaws, to illuminate the first portion of the first ear; and
triggering an optical detector, arranged on a second jaw of the set of jaws opposite the optical emitter, to capture a first image of the first portion of the first ear;
detecting a first set of features in the first image, the first set of features representing a first vein branch structure of the first ear;
compiling the first set of features into a first earprint of the first animal, the first earprint uniquely identifying the first animal;
associating the first earprint with a first identifier of the first animal;
writing the first earprint and the first identifier to a first electronic profile associated with the first animal; and
storing the first electronic profile in an electronic database comprising a set of electronic profiles associated with the population of animals.

12. The method of claim 11, further comprising, during a second time period succeeding the first time period:
during closure of the set of jaws over a second portion of a second ear of a second animal, in the population of animals:
triggering the optical emitter to illuminate the second portion of the second ear; and
triggering the optical detector to capture a second image of the second portion of the second ear;
detecting a second set of features in the second image, the second set of features representing a second vein branch structure of the second ear;
compiling the second set of features into a second earprint of the second animal;
retrieving the first earprint from the first electronic profile;
characterizing a first difference between the first set of ear features represented in the first earprint and the second set of ear features represented in the second earprint; and
in response to the first difference falling below a threshold difference:
matching the second earprint to the first earprint;
identifying the second animal as the first animal;
retrieving the first identifier from the first electronic profile; and
presenting the first identifier via a user interface.

13. The method of claim 12:
further comprising:
calculating a predicted difference in spatial distribution of ear features represented in two earprints generated based on images of a single ear captured on a time interval corresponding to a time difference between the first time period and the second time period;
calculating a threshold difference for the first earprint based on the predicted difference; and
wherein characterizing a first difference comprises calculating the first difference between spatial distribution of corresponding ear features in the first earprint and the second earprint.

14. The method of claim 12, further comprising:
during the first time period, triggering a tissue sample collection system, arranged on the set of jaws, to resect a tissue sample from the first ear of the first animal;
accessing a first genetic result derived from the tissue sample;
storing the first genetic result in the first electronic profile associated with the first animal; and
during the second time period:
in response to identifying the second animal as the first animal, accessing the first genetic result from the first electronic profile; and
based on the first genetic result, generating a culling notification for the first animal.

15. The method of claim 12, further comprising:
in response to matching the second earprint to the first earprint:
generating a combined earprint defining a combination of the first earprint and the second earprint;
writing the combined earprint to the first electronic profile; and
generating a combined set of ear features, corresponding to the combined earprint, defining a combination of the first set of ear features and the second set of ear features;
during a third time period succeeding the second time period:
during closure of the set of jaws over a third portion of a third ear of a third animal, in the population of animals:
triggering the optical emitter to illuminate the third portion of the third ear; and
triggering the optical detector to capture a third image of the third portion of the third ear;
detecting a third set of features in the third image, the third set of features representing a third vein branch structure of the third ear;
compiling the third set of features into a third earprint of the third animal;
retrieving the combined earprint from the first electronic profile; and
characterizing a third difference between the third set of ear features represented in the third earprint and the combined set of ear features represented in the combined earprint; and
in response to the third difference falling below a threshold difference:
matching the combined earprint to the third earprint;
identifying the third animal as the first animal;
retrieving the first identifier from the first electronic profile; and
presenting the first identifier via a user interface.

16. The method of claim 12, further comprising:
in response to matching the second earprint to the first earprint:
based on the first earprint and the second earprint, calculating rate of change of spatial distribution of ear features represented in two earprints generated based on images of a single ear;
during a third time period succeeding the second time period:
during closure of the set of jaws over a third portion of a third ear of a third animal, in the population of animals:
triggering the optical emitter to illuminate the third portion of the third ear; and
triggering the optical detector to capture a third image of the third portion of the third ear;
detecting a third set of features in the third image, the third set of features representing a third vein branch structure of the third ear;
compiling the third set of features into a third earprint of the third animal;
based on the rate of change and a time interval between the third time period and the second time period, generating a fourth ear print of the first animal; and
characterizing a third difference between the third set of ear features represented in the third earprint and a fourth set of ear features represented in the fourth earprint; and
in response to the third difference falling below a threshold difference:
matching the fourth earprint to the third earprint;
identifying the third animal as the first animal;
retrieving the first identifier from the first electronic profile; and
presenting the first identifier via a user interface.

17. The method of claim 12:
wherein characterizing the first difference between the first set of ear features represented in the first earprint and the second set of ear features represented in the second earprint comprises:
for each electronic profile stored in the electronic database:
characterizing a difference between a set of ear features represented in an earprint stored in the electronic profile and the second set of ear features represented in the second earprint; and
wherein matching the second earprint to the first earprint comprises matching the second earprint to the first earprint in response to:
the first difference between the first earprint and the second earprint falling below the threshold difference; and
the first difference between the first earprint and the second earprint falling below differences between the second earprint and earprints represented in each other electronic profile stored in the electronic database.

18. The method of claim 11:
further comprising:
accessing a quantity of animals in the population of animals; and
based on the quantity of animals, defining a target feature count in earprints for the population of animals; and
wherein detecting the first set of features in the first image comprises:
detecting the first set of features, comprising the target feature count, from the first image.

19. The method of claim 11, wherein associating the first earprint with the first identifier comprises:
detecting a set of characteristics of the first ear in the first image, the set of characteristics comprising:
a quantity of branches of the first vein branch structure;
a set of angles of branches in the first vein branch structure; and
a set of lengths of branches of the first vein branch structure; and
transforming the set of characteristics into the first identifier based on a stored numeric code.

20. A method for identifying animals comprising:
during closure of a set of jaws over an ear of an animal, in a population of animals:
triggering an optical emitter, arranged on a first jaw of the set of jaws, to illuminate a portion of the ear; and
triggering an optical detector, arranged on a second jaw of the set of jaws opposite the optical emitter, to capture an image of the portion of the ear;
detecting a set of features in the image, the set of features representing a vein branch structure of the ear;
compiling the set of features into a first earprint of the animal, the first earprint uniquely identifying the animal;
querying an electronic database, comprising electronic profiles of the population of animals, for an electronic profile comprising a stored earprint approximating the first earprint;
identifying a first electronic profile, in the electronic database, comprising the stored earprint approximating the first earprint; and
in response to identifying the first electronic profile:
accessing a first identifier stored in the first electronic profile;
based on the first identifier, identifying the animal; and
associating the first earprint with the first electronic profile.
